(19) United States
(12) Patent Application Publication
(10) Pub. No.: US 2010/0101295 A1
(43) Pub. Date: Apr. 29, 2010

(54) ISULATED SHEATH FOR BENDING POLYMER-BASED ROD

(75) Inventors: Keith E. MILLER, Germantown, TN (US); Harold Sparr TAYLOR, Memphis, TN (US)

Correspondence Address: MEDTRONIC;Attn: Noreen Johnson - IP Legal Department, 2600 Sofamor Danek Drive, MEMPHIS, TN, 38132, US

(73) Assignee: WARSAW ORTHOPEDIC, INC., Warsaw, IN (US)

(21) Appl. No.: 12/259,821

(22) Filed: Oct. 28, 2008

(51) Int. Cl. B21D 37/16; B29C 53/02

(52) U.S. Cl. 72/342.1; 72/364; 264/339

(57) ABSTRACT

Systems and methods are provided for bending an elongate member used in a medical procedure. In one form, a system includes an insulated fabric that is used to grasp and bend a heated elongate member. The elongated member is heated to its glass transition temperature (Tg) using a heating element. The insulated fabric may be lined with a non-stick coating to prevent adhesion of the heated elongate member to the insulated fabric. In another form, a PEEK rod is heated using a sheath. The inner surface of the sheath is lined with Teflon to prevent adhesion as stated above. The sheath includes a plurality of semi-rigid coils to assist in bending the rod and to prevent the rod from being crushed during the bending process. The heating element may be included in the semi-rigid coils in this form.

### BACKGROUND

The present invention generally relates to systems, devices and methods for bending an elongate member used in association with a medical procedure. In one form, the medical procedure is a spinal stabilization procedure wherein an orthopedic construct is engaged along the spinal column, and the elongate member is a rod component anchored to the spinal column by a number of bone anchors.

The use of spinal constructs to stabilize and support a portion of the spinal column has become commonplace. In particular, spinal constructs frequently include several bone anchors that are anchored to various portions of the spinal column, and an elongate rod that extends between and is engaged with the bone anchors to provide stabilization and support to the spinal column. Typically, the elongate rod is initially provided in a substantially straight configuration, and is subsequently bent or contoured to facilitate engagement with each of the bone anchors and/or to provide a desired spinal curvature.

In the past, bending or contouring of elongate rods was accomplished by instruments or tools that relied solely on application of a mechanical bending force. However, prior techniques and instrumentation for bending elongate rods required application of excessive bending forces, and also risked fracturing or weakening of the elongate rod and/or degrading the material properties associated with the elongate rod. In this regard, the desire persists for improved rod bending/contouring capabilities. Thus, there is a need for additional contributions in this area of technology.

### SUMMARY

One nonlimiting embodiment of the present invention is directed to a system for bending a heat deformable elongate member used in association with a medical procedure. In one form of the present invention, the medical procedure is a spinal stabilization procedure, and the elongate member is a rod component anchored to the spinal column by a number of bone anchors. However, bending of other types of elongate members is also contemplated by the present invention. Additionally, the heated heat deformable elongate member softens as it is heated to provide increased flexibility to facilitate bending/contouring of the elongate member.

In one embodiment, the system includes a heating element to heat a portion of a heat deformable rod. The rod is heated to its glass transition temperature (Tg). A portion of the heated rod adjacent to the heated portion is bent using an insulated fabric. The insulated fabric protects the user from being burned by the rod. The insulated fabric may include a plurality of semi-rigid coils to assist in the bending of the rod and yet presents limitations to prevent crushing of the rod. The underside of the insulated fabric is lined with a non-stick coating to prevent the softened rod from adhering to the fabric.

In another embodiment of the invention, the heat deformable elongate member is comprised of a thermoplastic material such as PEEK. The heat deformable elongate member can be a rod, plate and other comparable heat sensitive items. The insulated fabric is formed into a cylindrical sheath that surrounds the PEEK rod. The heating element is integrated into the plurality of semi-rigid coils that are used to aid in bending the rod, as well as protecting the structural integrity of the rod during the bending process. The inside surface of the sheath may be coated with Teflon to prevent the softened rod from adhering to the sheath.

Further embodiments, forms, features, aspects, benefits, objects and advantages of the present invention will become apparent from the detailed description and figures provided herewith.

### BRIEF DESCRIPTION OF THE FIGURES

FIG. 1 is a top view of one embodiment of the invention.

FIG. 2 is perspective view of another embodiment of the invention, and

FIG. 3 is a cross-sectional view of the embodiment described in FIG. 2.

### DESCRIPTION OF THE ILLUSTRATED EMBODIMENTS

For the purposes of promoting an understanding of the principles of the invention, reference will now be made to the embodiments illustrated in the drawings, and specific language will be used to describe the same. It will nevertheless be understood that no limitation on the scope of the invention is intended. Any alterations and further modifications in the illustrated devices and described methods and further applications of the principles of the invention as disclosed herein are contemplated as would normally occur to one skilled in the art to which the invention relates.

Systems, devices and methods for bending or contouring an elongate member used in association with a medical procedure are provided. In one form, the medical procedure is part of a stabilization procedure wherein a spinal construct is engaged along the spinal column. In a further form, the elongate member is a rod component anchored to the spinal column by a number of bone anchors to provide stabilization and support to the spinal column. However, other types of elongate members are also contemplated for use in association with the present invention, including plate components or other suitable types of elongate support components. In one embodiment, the bone anchors are initially anchored to portions of the spinal column, followed by engagement of the rod component to the bone anchors. The rod component may require bending or contouring to allow for interconnection with the bone anchors and/or to provide a desired spinal curvature. The spinal construct may be used in association with, but is not limited to, treatment of degenerative spondylolisthesis, fracture, dislocation, scoliosis, kyphosis, or spinal tumors.

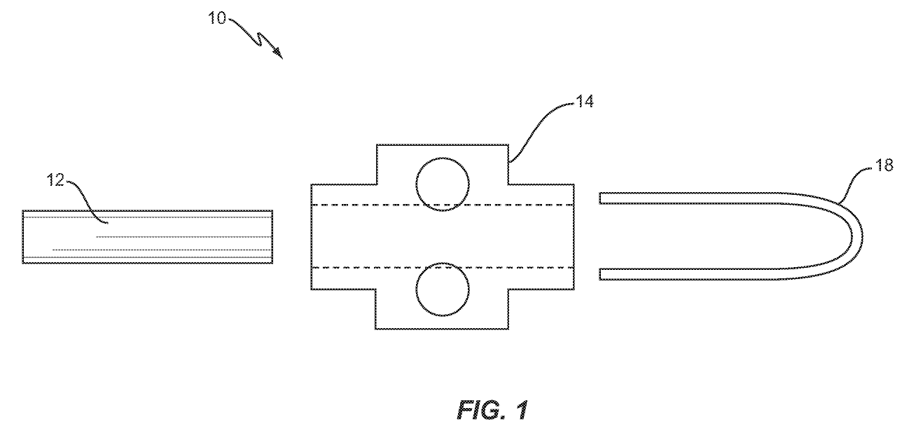

Referring to FIG. 1, illustrated therein is a system 10 for bending an elongate surgical member 12. As indicated above, other types of elongate members are also contemplated for use in association with the present invention, including plate components or other suitable types of elongate support components. The system 10 includes a heating element 14 that can heat the elongate surgical member 12 to its glass transition temperature (Tg) for bending. The elongate member 12 is presented to the heating element 14 that heats to the Tg. Once the Tg is reached, an insulated fabric 16 is used to grasp the softened elongate surgical member 12 and bend it to a desired contour. The bent elongate surgical member 12 is then set aside to cool before placement in a spinal construct.

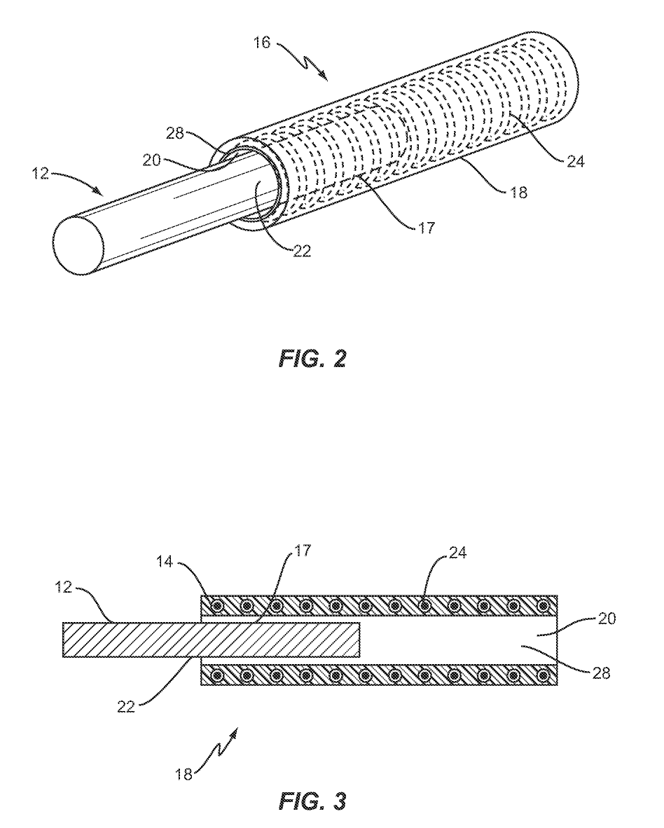

FIG. 2 illustrates the insulated fabric 16 has been formed into a cylindrically shaped sheath 18. The sheath 18 is designed to mimic the profile of the elongate surgical member 12. In this embodiment the elongate surgical member is a PEEK rod. The heat deformable elongate member 12 may comprise numerous thermoplastic polymers. Examples of thermoplastic polymers include, for example, high molecular weight organic polymers. More particular examples of thermoplastic polymers include, without limitation, polycarbonate, polyketone, polyester, polyethylene, polyetheretherketone (PEEK), polyimide, polylactic acid,polypropylene, polystyrene, polysulfone, polyvinyl chloride, polyamide, poly(tetrafluoroethene), polyphthalamide, polybutylene and mixtures thereof, just to name a few possibilities. The rod may also be formed from one or more metals or metal alloys that are amenable to increased flexibility when heated. A select portion of the rod 17 is placed in one end of the sheath 18. The inner surface of the sheath 20 is lined with a non-stick coating 28 such as Teflon to prevent the heated rod from sticking to the sheath 20. A plurality of semi-rigid coils 24 is disposed within the sheath 20 to aid in the bending process and to resist crushing of the rod (FIG. 3). The heating element 14 is disposed within the plurality of semi-rigid coils 24 in this embodiment. The heating element 14 may be configured to provide heat via convection heating, conduction heating, infrared heating, or any other type of heating known to those of skill in the art. Additionally, the heating element 14 may utilize power from an internal or external power source (not shown) to provide heat in a variety of manners including, for example, via a coil resistance heater, a metal oxide resistance heater, or a Positive Temperature Coefficient (PTC) heater, just to name a few possibilities. Upon heating, the rod portion adjacent the heated portion 22 is grasped by the user via the sheath 18 and bent to the desired contour. The rod is then set aside to cool. The sheath 18 prevents the rod from cooling off too quickly and thus assists in maintaining the structural integrity of the rod during both the heating and the cooling processes.

Any theory, mechanism of operation, proof, or finding stated herein is meant to further enhance understanding of the present invention, and is not intended to make the present invention in any way dependent upon such theory, mechanism of operation, proof or finding. It should be understood that while the use of the word preferable, preferably or preferred in the description above indicates that the feature so described may be more desirable, it nonetheless may not be necessary, and embodiments lacking the same may be contemplated as within the scope of the application, that scope being defined by the claims that follow. In reading the claims, it is intended that when words such as “a,” “an,” “at least one,” “at least a portion” are used, there is no intention to limit the claim to only one item unless specifically stated to the contrary on the claim. Further, when the language “at least a portion” and/or “a portion” is used, the item may include a portion and/or the entire item unless specifically stated to the contrary.

While the application has been illustrated and described in detail in the drawings and foregoing description, the same is to be considered as illustrative and not restrictive in character, it being understood that only the selected embodiments have been shown and described and that all changes, modifications and equivalents that come within the spirit of the invention as defined herein or by any of the following claims are desired to be protected.

What is claimed is:

1. A system for bending an elongate surgical member comprising:
an insulated fabric suitably sized to cover a select portion of the elongate surgical member; and
a heating element to apply heat to the select portion of the elongate surgical member.

2. The system of claim 1, wherein the heating element heats the select portion of the elongate surgical member to a malleable temperature.

3. The system of claim 1, wherein the heating element is coupled to the insulated fabric.

4. The system of claim 2, wherein the heating element heats the select portion of the elongate surgical member to its glass transition temperature (Tg).

5. The system of claim 1, wherein the insulated fabric includes a sheath that can be bent without permanent deformation.

6. The system of claim 5, further comprising a plurality of semi-rigid coils located in the insulated fabric to resist crushing of the elongate surgical member.

7. The system of claim 5, wherein the sheath includes a cylindrical shape mimicking and surrounding the elongate surgical member.

8. The system of claim 1, wherein the sheath includes a non-sticking coating on the inside surface to prevent adherence to the elongate surgical member when heated.

9. The system of claim 8, wherein the non-sticking coating includes Teflon.

10. The system of claim 1, wherein the elongate surgical member includes a heat deformable rod.

11. The system of claim 1, wherein the elongate surgical member includes a heat deformable plate.

12. A system for bending an elongate surgical member, comprising:
an insulated cylindrically-shaped sheath;
a plurality of semi-rigid coils distributed in the sheath; and
wherein a heating element is integrated into the plurality of semi-rigid coils.

13. The system of claim 12, wherein the sheath includes a Teflon coating along the inside surface.

14. The system of claim 12, wherein the elongate surgical member is a heat deformable spinal rod.

15. The system of claim 12, wherein the elongate surgical member is a heat deformable plate.

16. The system of claim 12, wherein the elongate surgical member is comprised of a thermoplastic material.

17. The system of claim 16, wherein the thermoplastic material comprises a polymer-based material.

18. The system of claim 17, wherein the polymer-based material comprises a PEEK material.

19. A method for bending an elongate surgical member, comprising:
providing a heat deformable elongate surgical member;
providing an insulated sheath that can be bent around the elongate surgical member;
providing a heating element to heat a select portion of the elongate surgical member;
heating the select portion of the elongate surgical member with the heating element; and
bending the elongate member portion adjacent the select portion of the elongate member while holding the elongate member via the insulated sheath.

20. The method of claim 19, wherein the insulated sheath includes a plurality of semi-rigid coils for bending of the elongate member.

21. The method of claim 19, further comprising providing a non-stick coating on an inner surface of the insulated sheath to prevent the softened select portion of the elongate member from adhering to the insulated sheath.

22. The method of claim 21, wherein the non-stick coating is Teflon.

23. The method of claim 19, wherein the heating element heats the select portion of the elongate member to its glass transition temperature (Tg).

24. The method of claim 19, wherein the heat deformable elongate surgical member is a spinal rod.

25. The method of claim 19, wherein the heat deformable elongate surgical member is a plate.

26. The method of claim 24, wherein the spinal rod is comprised of a polymer-based material.

27. The method of claim 26, wherein the polymer-based material comprises a PEEK material.
